(19) United States
(12) Patent Application Publication
(10) Pub. No.: US 2015/0014968 A1
(43) Pub. Date: Jan. 15, 2015

(54) MOTOR VEHICLE INSTRUMENT PANEL WITH AIRBAG DEPLOYMENT OPENING

(71) Applicant: FORD GLOBAL TECHNOLOGIES, LLC, Dearborn, MI (US)

(72) Inventors: Timothy SCOTT, Benfleet (GB); Heiko DIETSCH, Bonn (DE); Robert GRZELAK, Dormagen (DE); Jovica John JAKOVSKI, Macomb Township, MI (US)

(21) Appl. No.: 14/324,029

(22) Filed: Jul. 3, 2014

(30) Foreign Application Priority Data
Jul. 9, 2013 (DE) 10 2013 213 401.0

(51) Int. Cl. B60R 21/2165; B60R 21/205

(52) U.S. Cl. CPC B60R 21/2165; B60R 21/205
USPC 280/728.3

(57) ABSTRACT

The invention relates to an occupant protection airbag system for a motor vehicle. The airbag is stored in the vehicle instrument panel behind an airbag opening comprising a plurality of flaps constructed integrally with the instrument panel. The flaps open along respective separation lines and pivot about hinge lines when the airbag inflates. A single central flap has a hinge line located at the side of the instrument panel opening facing the windshield, and the separation line adjoining the hinge line extends in a substantially U-shaped manner. Left and right lateral flap which open toward each side are provided at both sides of the central flap. The portions of the lateral flap separation lines opposite from their respective hinge lines coincide with the lateral portions of the central flap separation lines.

### CROSS-REFERENCE TO RELATED APPLICATIONS

This application claims foreign priority benefits under 35 U.S.C. §119(a)-(d) to DE 10 2013 213 401.0 filed Jul. 9, 2013, which is hereby incorporated by reference in its entirety.

### TECHNICAL FIELD

The invention relates to an occupant protection airbag system for a motor vehicle, and more particularly to such a system in which an airbag is mounted in an instrument panel at least one flap which closes the opening, which is constructed integrally with the instrument panel and which opens along a predetermined separation line when the airbag inflates and which pivots open about a hinge line which is formed.

### BACKGROUND

There are already known various airbag systems in which the separation lines which act as desired breaking lines and the predetermined hinge lines about which the flaps can be pivoted are arranged in accordance with various patterns.

US 2010/0045005 A1 discloses, for example, a flap arrangement in which there are provided an upper flap which can be pivoted open toward the windshield and which reaches substantially as far as the center of the opening, and two lateral flaps which cover the front portion of the opening. Such a flap arrangement has the disadvantage that the lateral flaps when activated protrude to a great extent into the passenger space.

### SUMMARY

An object of the invention is therefore to provide an airbag system in which the flap arrangement is constructed in such a manner that injuries to a vehicle occupant are prevented and it can further be ensured that the flaps are opened in a reliable manner in the event of an impact of the vehicle.

In a disclosed embodiment of the invention, a single central flap is provided. The hinge line of the central flap, which line forms the pivot axis, is located along the upper edge of the instrument panel airbag opening, the edge most closely adjacent to the windshield. The separation line which adjoins the hinge line extends downward from the hinge line in a substantially U-shaped manner. A left and a right lateral flap are provided at either side of the central flap, respectively. The separation lines of the lateral flaps coincide with the separation line of the central flap at the sides opposite the hinge lines of the lateral flaps.

The flap arrangement according to the invention ensures easy and reliable airbag opening in the event of an impact of the vehicle, the airbag itself then deploying if one of the flaps should not open or not open immediately. Furthermore, the flap arrangement according to the invention ensures a sufficient level of rigidity with respect to undesirable pressing down of the flaps from the outer side so that the instrument panel always has a surface without any defects.

Preferably, the portion of the separation line opposite the hinge line of the central flap extends substantially parallel with the hinge line of the central flap.

This parallel extending portion of the separation line, which portion is opposite the hinge line of the central flap, is advantageously constructed to be shorter than the length of the hinge line. The opening of the separation line in the event of an airbag deployment is thereby significantly facilitated.

The lateral portions of the separation line of the central flap extend in this instance at an acute angle with respect to the hinge line, the two angles being arranged symmetrically and being located in a range from 60 to 80 degrees.

In order to facilitate the separation operation, the lateral portions of the separation line of the central flap may be angled slightly toward the center.

The hinge lines of the lateral flaps advantageously extend substantially perpendicularly relative to the hinge line of the central flap.

The length of the hinge lines of the lateral flaps preferably corresponds to the height of the central flap, that is to say, the lateral flaps which are arranged laterally beside the central flap are in alignment with the central flap.

The upper and lower portions of the separation lines of the lateral flaps extend in this instance substantially parallel with the hinge line of the central flap.

The lateral flaps may in this instance be constructed in such a manner that the upper portions of the separation lines of the lateral flaps, which portions are most closely adjacent to the windshield, are constructed so as to be shorter than the lower portions of the separation lines of the lateral flaps, which portions are farthest from the windshield, whereby the separation operation is facilitated in the event of an airbag deployment.

### BRIEF DESCRIPTION OF THE DRAWINGS

The invention is illustrated in the drawings by way of example and described in detail below with reference to the drawings.

FIG. 1 shows a portion of an instrument panel with a schematic illustration of the flap system, and

FIG. 2 is an enlarged view of the geometric division of the flap system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

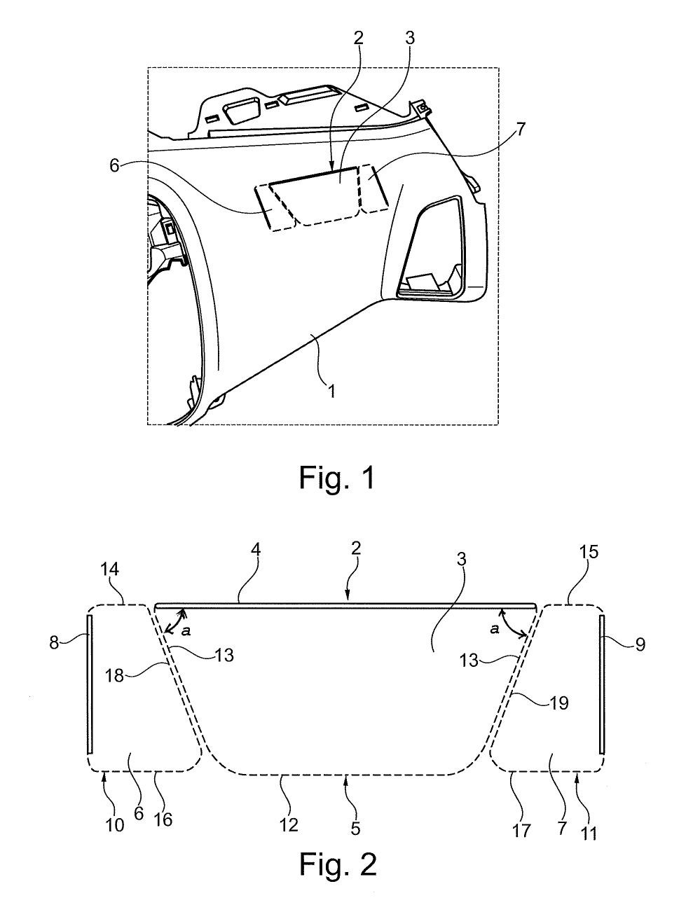

FIG. 1 of the drawings shows a portion of an instrument panel 1. Behind the instrument panel 1 is an airbag which is folded together, which is not illustrated in the drawing and which is automatically inflated in the event of an impact.

The portion of the instrument panel 1 which is located directly in front of the airbag is constructed in the form of a flap system 2 which is formed integrally with the instrument panel 1 and which, in the event of an impact, releases an opening through which the airbag can deploy in the passenger space.

The flap system 2 is defined by a plurality of separation lines which act as desired breaking locations in the event of an impact and enable the flaps to be opened.

In the embodiment illustrated in the drawings, there is provided a single central flap 3 having a perimeter defined by a hinge line 4 and a separation line 5. The hinge line 4 forms the pivot axis is located at the side of the instrument panel facing the windshield, that is to say that the hinge line 4 in the embodiment illustrated in FIG. 1 is arranged adjacent to the top of the instrument panel so that the flap 3 pivots upward in the direction toward the windshield in the event of an airbag deployment.

The separation line 5 (indicated in dashed lines) of the central flap 3 which adjoins the hinge line 4 extends substantially in a U-shaped manner, from the hinge line 4 in the direction toward the passenger space.

There is provided at both sides of the central flap 3 a left lateral flap 6 and a right lateral flap 7 which open toward the left and right sides, respectively, and whose hinge lines 8 and 9 extend perpendicularly relative to the hinge line 4 of the central flap 3.

The left lateral flap 6 has a perimeter defined by hinge line 8 and a separation line 10. The right lateral flap 7 has a perimeter defined by hinge line 9 and a separation line 11.

The separation lines 10 and 11 (indicated in dashed lines) of the lateral flaps 6 and 7 coincide at the sides opposite their hinge lines 8 and 9 with the separation line 5 of the central flap 3, respectively.

The bottom portion 12 of the separation line 5 opposite the hinge line 4 of the central flap 3 extends substantially parallel with the hinge line 4 of the central flap 3 and is constructed to be slightly shorter than the length of the hinge line 4.

The lateral portions 13 of the separation line 5 of the central flap 3 extend at an acute angle a with respect to the hinge line 4, in an angular range from approximately 60 to 80 degrees, and they are angled toward a lateral center of the airbag opening.

The length of the hinge lines 8 and 9 of the lateral flaps 6 and 7 corresponds to the height of the central flap 5. The upper and lower portions 14, 15 and 16, 17 of the separation lines 10 and 11 of the lateral flaps 6 and 7 extend parallel with the hinge line 4 of the central flap 3, respectively, the upper portions 14 and 15 of the separation lines 10 and 11 being in alignment with the hinge line 4 of the central flap 3, whilst the lower portions 16 and 17 of the separation lines 10 and 11 of the lateral flaps 6 and 7 are in alignment with the bottom portion 12 of the separation line 5 of the central flap 3, which portion is opposite the hinge line 4, respectively.

The upper portions 14, 15 of the separation lines 10 and 11 of the lateral flaps 6 and 7, which portions are closest to the windshield, are constructed to be shorter than the lower portions 16 and 17 of the separation lines 10 and 11 of the lateral flaps 6 and 7, which portions are facing away from the windshield, respectively.

According to the drawing, the lateral portions 13 of the separation line 5 of the central flap 3 coincide with the separation portions 18 and 19 of the lateral flaps 6 and 7 opposite the hinge lines 8 and 9, respectively. That is to say, when the central flap 3 is opened, the lateral flaps 6 and 7 can also open freely to the greatest possible extent.

In this construction, the central flap 3 and the two laterally adjacent lateral flaps 6 and 7 define a rectangle. In the event of an airbag deployment, when the airbag inflates, there is consequently produced a rectangular opening through which the inflating airbag can pass and deploy into the passenger space.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A motor vehicle instrument panel having a an airbag opening comprising a plurality of flaps constructed integrally with and forming a portion of a surface of the instrument panel, each flap having a perimeter defined by a separation line along which the flap separates from adjacent portions of the surface and by a hinge line about which the flap pivots, the plurality of flaps comprising:
a central flap having a hinge line located at an edge of the airbag opening adjacent to a top of the instrument panel, and a separation line extending downward from the hinge line in a substantially U-shaped manner; and
a left lateral flap and a right lateral flap disposed at opposite sides of the central flap, each of the lateral flaps having a hinge line extending downward from the central flap hinge line, and a separation line having a portion opposite from the lateral flap hinge line that coincides with the central flap separation line.

2. The instrument panel of claim 1, wherein the central flap separation line comprises a bottom portion opposite from and extending substantially parallel with the central flap hinge line.

3. The instrument panel of claim 2, wherein the bottom portion of the central flap separation line is shorter than the central flap hinge line.

4. The instrument panel of claim 3, wherein the central flap separation line further comprises left and right lateral portions, each connecting a respective end of the hinge line with a respective end of the bottom portion of the central flap separation line, and each lateral portion extending at an acute angle with respect to the hinge line.

5. The instrument panel of claim 4, wherein the acute angle between the central flap hinge line and the lateral portions of the central flap separation line is approximately from 60 to 80 degrees.

6. The instrument panel of claim 4, wherein the lateral portions of the central flap separation line are angled toward a lateral center of the airbag opening.

7. The instrument panel of claim 1, wherein the lateral flap hinge lines are substantially perpendicularly to the central flap hinge line.

8. The instrument panel of claim 7, wherein of the lateral flap hinge lines have lengths substantially equal to a height of the central flap.

9. The instrument panel of claim 1, wherein the of the lateral flap separation lines comprise upper and lower portions that are substantially parallel with the central flap hinge line.

10. The instrument panel of claim 1, wherein the lateral flap separation lines comprise upper portions adjacent to the top of the instrument panel and lower portions adjacent to a bottom of the instrument panel, the upper portion being shorter than the lower portions.
